(19) United States
(12) Patent Application Publication
(10) Pub. No.: US 2026/0216950 A1
(43) Pub. Date: Jul. 30, 2026

(54) METHOD FOR APPLYING A DECORATIVE FILM ONTO A NON-PLANAR SURFACE

(71) Applicants: Bayerische Motoren Werke Aktiengesellschaft, München (DE); E INK CORPORATION, Billerica, MA (US)

(72) Inventors: Stella CLARKE, Garching (DE); Jennifer B. LAMPRON, Newton, NH (US); Eric J. DUCHAINE, East Hampstead, NH (US)

(21) Appl. No.: 18/725,035

(22) PCT Filed: Dec. 29, 2022
(86) PCT No.: PCT/EP2022/088005

§ 371 Date: Apr. 17, 2026

(30) Foreign Application Priority Data
Jan. 1, 2022 (DE) 10 2022 000 002.4

(51) Int. Cl. B29C 63/00; B29C 63/02; B29L 31/30

(52) U.S. Cl. CPC B29C 63/0073; B29C 63/02; B29C 2793/0036; B29C 2793/0081; B29L 2031/3005

(57) ABSTRACT

A method for applying an inherently stiff decorative film with a decorative layer onto a non-planar surface, the method including: a) providing the decorative film; b) applying an adhesive layer onto the decorative film; c) applying the decorative film onto an adhesive supporting film forming a sandwich film; d) cutting a predefined pattern of compression slits which extend away from one another in a star shape or a diamond shape and linear expansion slits into the decorative film such that the compression slits and the expansion slits penetrate the decorative film in the thickness direction; e) applying the sandwich film onto the non-planar surface, the sandwich film being adapted to convex regions of the non-planar surface by stretching the adhesive supporting film and the decorative film, and the sandwich film being adapted to concave regions of the non-planar surface by compressing the adhesive supporting film and the decorative film.

### TECHNICAL FIELD

The invention relates to a method for applying an inherently stiff decorative film onto a non-planar surface according to the preamble of patent claim 1. It further relates to a decorative film suitable for this purpose, a film composite comprising such a film and a vehicle, in particular a motor vehicle, with an outer body skin which has been provided with such a decorative film by means of a method according to any of the preceding claims.

### BACKGROUND OF THE INVENTION

Automotive customers often want to be able to customise and personalise the exterior of their vehicles. Although this has been possible up to now using customised vehicle paintwork or partial paintwork or by film-wrapping the outer body skin, such individual vehicle designs can only be changed with considerable effort and, in particular, not based on the situation. In the case of wrapping with a decorative film, the decorative film must be highly flexible, stretchable and compressible, which is difficult with thicker and stiffer decorative films. It may also be desirable to flexibly adapt the external appearance of the vehicle to a specific driving purpose—serious and restrained for use as a business vehicle or brightly coloured for surfing holidays at the beach.

### PRIOR ART

It is already known to cover curved and cambered surfaces with highly flexible, stretchable and compressible decorative films; up to now this has not been possible with stiffer films, such as wood veneer or e-paper films. It is also known to provide display devices on the vehicle body that operate using e-paper technology and can be switched between different visual appearances, but up to now this has only been possible on flat surfaces of the vehicle body.

### DESCRIPTION OF THE INVENTION

The object of the present invention is to specify a method for applying a decorative film onto a non-planar surface, by means of which the decorative film can be flexibly adapted to any three-dimensionally shaped surface.

This object is solved with the features of patent claim 1 and alternatively of patent claim 2.

A first solution to the object is a method for applying an inherently stiff decorative film with a decorative layer onto a non-planar surface, preferably an outer body skin of a motor vehicle, which is characterised by the following steps:
a) providing the decorative film;
b) applying an adhesive layer onto the decorative film;
c) applying the decorative film provided with the adhesive layer onto an adhesive supporting film in order to form a sandwich film;
d) cutting a predefined pattern of compression slits which extend away from one another in a star shape or are designed in a diamond shape and linear expansion slits into the e-paper film in such a way that the compression slits and the expansion slits penetrate the decorative film in the thickness direction, and
e) applying the sandwich film onto the non-planar surface, the sandwich film being adapted to convex regions of the non-planar surface by stretching the adhesive supporting film and the decorative film, and the sandwich film being adapted to concave regions of the non-planar surface by compressing the adhesive supporting film and the decorative film.

A second alternative solution to the object is a method for applying an inherently stiff decorative film with a decorative layer to a non-planar surface, preferably an outer body skin of a motor vehicle, which is characterised by the following steps:
a) providing the decorative film;
b) applying an adhesive layer onto the decorative film;
c′) cutting a predefined pattern of compression slits which extend away from one another in a star shape or are designed in a diamond shape and linear expansion slits into the decorative film in such a way that the compression slits and the expansion slits penetrate the decorative film in the thickness direction;
d′) applying the decorative film provided with the adhesive layer onto an adhesive supporting film in order to form a sandwich film, and
e) applying the sandwich film onto the non-planar surface, the sandwich film being adapted to convex regions of the non-planar surface by stretching the adhesive supporting film and the decorative film, and the sandwich film being adapted to concave regions of the non-planar surface by compressing the adhesive supporting film and the decorative film.

An “inherently stiff” decorative film is not to be understood here as a rigid decorative film, but rather as a decorative film with limited flexibility in its initial state, which can be bent in one direction but which cannot be bent in two different directions, i.e. around two different axes, at the same time. The bendability of the decorative film in its initial state may also be limited to larger bending radii and not permit tight bending radii.

The application of the respective method is not limited to the wrapping of non-planar surfaces of the outer body skin of a motor vehicle, but can be applied to almost all three-dimensionally shaped surfaces, in particular also to surfaces present in the interior of a motor vehicle.

### Advantages

The design of the decorative film according to the invention with a pattern of individual slits penetrating the decorative film in the thickness direction means that the unslit, inherently almost stiff decorative film becomes flexible in three dimensions due to the slit pattern of the invention. Slitting is preferably carried out using laser beams, a cutting plotter or other cutters so that the individual slits are extremely narrow and therefore barely visible when the decorative film is in the flat state.

To ensure that the slit decorative film remains handleable and processable upon being applied to the non-planar surface, it is, before slitting, first of all provided on the side of its supporting layer at least with an adhesive layer that is not slit during the subsequent slitting of the decorative film and that gives the slit decorative film the stability required for subsequent processing. For its part, the adhesive layer is flexible, stretchable and compressible. The decorative film provided with the adhesive layer can be applied to an adhesive supporting film before or after slitting. Thereby the adhesive layer is bonded to the supporting film. The supporting film is also flexible, stretchable and compressible. If the step of slitting the decorative film takes place after it has been bonded to the supporting film, only the decorative film is slit and the supporting film remains intact. In this way, a sandwich film is created from the slit decorative film, the adhesive layer and the supporting film—as a flexible, stretchable and compressible film composite. A suitable supporting film is, for example, a generally known car wrapping film used for vehicle wrapping.

The compression regions of the slit decorative film can be compressed due to their star-shaped or diamond-shaped structure, which is necessary, for example, if the decorative film has to adapt locally to a depression or indentation in the substrate, such as for example the outer skin of the vehicle body. Thereby the tapering surface regions of the decorative film that remain between the star-shaped compression slits can converge or even overlap, bridging the respective compression slit, so that the decorative film is contracted at this point, i.e. its area is compressed.

In the expansion regions, the decorative film can be stretched in a direction transverse, for example at right angles, to the longitudinal direction of the at least one expansion slit, i.e. its area is expanded, so that the width of such an expansion slit increases, at least in its central region.

Due to their inherent elasticity and compressibility, the adhesive layer and the supporting film are able to withstand both the compression of the sandwich film in the compression regions of the decorative film and the expansion of the sandwich film in the expansion regions of the decorative film.

The non-planar surface can be bent (two-dimensionally curved) or cambered (three-dimensionally curved), the curvature being convex or concave; convex and concave regions can also alternate and the radii of curvature thereof can also vary.

Further preferred and advantageous design features of the method according to the invention form the subject matter of dependent claims 3 to 9.

The predefined pattern of compression slits and expansion slits is preferably cut into the decorative film by means of a laser beam.

It is also advantageous if, after the sandwich film has been applied to the non-planar surface, in a further step e) a protective layer consisting of a transparent protective film or a clear lacquer layer is applied to the sandwich film.

A particularly advantageous variant of the method according to the invention, which can be combined with other variants, provides that convex and concave regions of the non-planar surface are first identified by means of a CAD program and marked with a convex marking and a concave marking, respectively, in order to determine the predefined pattern, the non-planar surface marked in this way is unwrapped into a plane, the coordinates of the convex markings and the concave markings are transferred to the planar decorative film and the convex markings determine expansion regions into which the expansion slits are cut while the concave markings determine compression regions into which the compression slits, which extend away from one another in a star shape or are designed in a diamond shape, are cut.

According to a further preferred variant of the method according to the invention, which can be combined with other variants, first compression regions are provided, in which the compression slits, which extend away from one another in a star shape, have a common centre that penetrates the decorative film in the thickness direction.

Furthermore, second compression regions are preferably provided, in which the inner ends of the compression slits, which extend away from one another in a star shape, are spaced apart from one another in the centre of the compression element, so that an intact region of the decorative film is formed in the centre, in which the decorative film is not cut through in the thickness direction. The intact centre of these second compression regions means that, if electrode layers are present, the electrical conduction in the electrode layers of the decorative film, which is configured as an e-paper film for example, is not interrupted at these locations, thereby significantly reducing the overall conduction resistance in the respective electrode layer.

It is also advantageous if the decorative film provided in step a) is trimmed to a predefined outer contour during or before step a), and if the sandwich film formed in step c) or d′) is then trimmed to the same outer contour, the thereby made circumferential cutting line that cuts through the supporting film being spaced apart from the outer contour line of the decorative film. This prevents the circumferential edge of the decorative film from being damaged by this trimming of the sandwich film along its circumference. This is particularly advantageous if cutting is carried out using a laser beam, the intensity of which must be greater for cutting the supporting film than for cutting the decorative film due to the greater thickness of the supporting film.

Preferably, the decorative film has a first electrode layer, a second electrode layer and a decorative layer arranged between the two electrode layers, the light reflection properties or light transmission properties of which can be changed by applying an electrical voltage, and the first electrode layer and the second electrode layer of the decorative film provided in step a) are provided, during or before step a), with electrically conductive contact tabs, each of which is preferably pivotable about an axis lying in the plane of the respective electrode layer.

Electrical current is introduced into the respective electrode layer through these contact tabs in order to bring about a change in the state of the decorative film, which is configured as an e-paper film, for example. The pivotability of the contact tabs makes it possible to pivot the respective contact tab out of the plane of the associated electrode layer so that it can then be guided through a correspondingly assigned opening in the non-planar surface to be covered with the sandwich film. This way the contacts of the electrode layers are invisible after the sandwich film has been fitted, for example on the outer skin of a vehicle body. Alternatively, contact tabs can also be covered with black, white or coloured film or painted over.

The sandwich film applied to the non-planar surface can then be covered with a coloured film if required to achieve colour effects. The sandwich film applied to the non-planar surface can also be covered with a transparent film or a layer of clear lacquer for protection.

It is particularly advantageous if the decorative film configured as an e-paper film works according to the principle of advanced colour e-paper technology, by means of which it is possible to display any colour and switch between any colours. This makes it possible, for example, for a vehicle that is used for business and has a specific colour for this purpose (e.g. taxi beige or taxi yellow or a CI colour of the company) to appear in a different exterior colour for private use.

Of course, it is also possible and included in the invention to provide only certain regions of a vehicle body outer skin with the decorative film or to provide different regions of the vehicle body outer skin with different decorative films formed by e-paper films in order to make smaller segments or shaped regions of the vehicle body outer skin colour-switchable. A further idea included in the invention is to incorporate into the sandwich film, which is equipped with an e-paper film as a decorative film, a flexible active matrix display element as a TFT layer so as to allow the display of characters and symbols.

The invention also relates to a sandwich film produced according to the method of the invention with a decorative film which is bonded to a supporting film by means of an adhesive layer. The adhesive layer and the supporting film are flexible, stretchable and compressible. The decorative film, which is fairly stiff in its initial state, also becomes a flexible, stretchable and compressible decorative film by cutting a predefined pattern of compression regions and expansion regions in accordance with the invention. The sandwich film produced in this way assumes these properties and can be adapted particularly well to the surface profile of a non-planar surface, such as for example an outer body skin of a vehicle.

The decorative film advantageously has a plurality of star-shaped compression elements with different numbers of compression slits that extend away from one another in a star shape. Such a decorative film has regions of varying flexibility and can therefore be adapted to substrates with surfaces having different degrees of three-dimensional shaping.

It is particularly advantageous if the number of expansion elements per unit area in those regions of the decorative film that can be adapted to a convex surface region is greater, the smaller the radius of curvature of the convex surface region.

It is also advantageous if the number of compression elements per unit area in those regions of the decorative film that can be adapted to a concave surface region is greater, the smaller the radius of curvature of the concave surface region.

The decorative layer of the decorative film is preferably a smart glass LCD layer that is switchable between transparent and opaque, or an e-paper layer that is switchable between two colours. However, the decorative layer can also be a wood veneer layer, for example.

Finally, the invention also relates to a vehicle, in particular a motor vehicle, with an outer body skin that has been provided, at least in certain regions, by means of a method according to any of the preceding claims, with a sandwich film comprising such a decorative film, for example in the form of an e-paper film.

Preferred embodiments of the invention with additional design details and further advantages are described and explained in more detail below with reference to the attached drawings.

### BRIEF DESCRIPTION OF DRAWINGS

These show the following:

FIG. 1 A motor vehicle with a vehicle body having an outer body skin;

FIG. 2 A schematic representation of the structure of an e-paper display device in an enlarged longitudinal section;

FIG. 3 A section of a surface of a three-dimensionally deformed decorative film according to the invention with compression regions and expansion regions according to a first embodiment;

FIG. 4 An enlarged compression region according to a first variant;

FIG. 5 An enlarged expansion region;

FIG. 6 A longitudinal section through a sandwich film produced according to the method of the invention, and

FIG. 7 A section of a surface of a three-dimensionally deformed decorative film according to the invention with compression regions and expansion regions according to a second embodiment.

### DESCRIPTION OF PREFERRED EMBODIMENTS

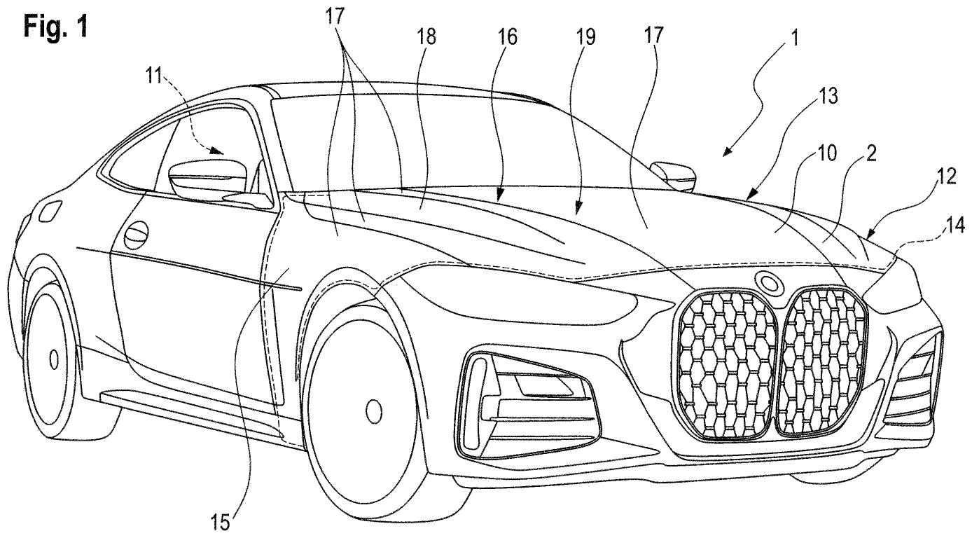

FIG. 1 shows a motor vehicle 1 with a vehicle body 12 having an outer body skin 10 and a vehicle interior 11 at least partially surrounded thereby. In the region of the front bonnet 13 and the front wings 14, 15, the outer body skin 10 is wrapped according to the method of the invention with a below-described sandwich film 19 according to the invention, as shown schematically by dashed lines. In this region, the outer body skin 10 forms a non-planar surface 16 with convex portions 17 and concave portions 18.

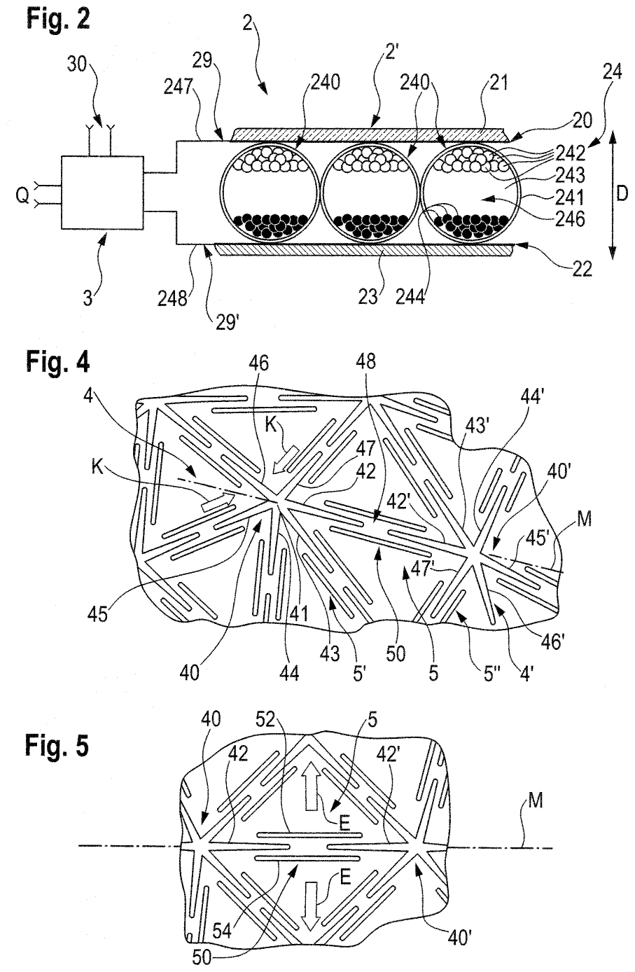

FIG. 2 is an enlarged longitudinal section of a representation of the structure of an e-paper film 2′ known per se, which forms a decorative film 2 according to the invention. The e-paper film 2′ has a first flat (upper) transparent electrode layer 20 with a transparent cover layer 21, a second flat (lower) electrode layer 22 with a supporting layer 23 and a display layer arranged between the two electrode layers 20, 22, which forms the changeable decorative layer 24.

The first, upper electrode layer 20 is connected by least at one upper connection tab 29 to an electrical control device 3 via a first electrically conductive connection 247, and the second, lower electrode layer 22 is also connected by at least one lower connection tab 29′ to the control device 3 via a second electrically conductive connection 248. The control device 3 is supplied with electrical energy from an electrical power source Q. The control device 3 also receives control signals via control lines 30.

The changeable decorative layer 24 of the e-paper film 2′ is provided with a plurality of display spheres 240 configured as microcapsules. Each of the display spheres 240 has a transparent housing wall 241 that encloses an interior 246 of the display sphere 240. The interior 246 contains a plurality of first pigments 242 of a first colour (here white) and a plurality of second pigments 244 of a second colour (here black) which are surrounded by a transparent fluid 243, the black pigments 244 usually being positively charged and the white pigments 242 negatively charged.

When a positive or negative electric field is activated by applying a voltage to the electrodes 20, 22, the black pigments 244 and the white pigments 242 move to the respective opposite electrodes 20, 22. The pigment particle quantity that moves to the upper (transparent) electrode 20 is visible to the observer as a black or white dot. Further developments of this shown e-paper film 2′ with a plurality of different display spheres containing coloured pigments instead of white pigments 242 are able to display colours.

The control device 3 provides the electrodes 20, 22 with an electrical switching signal with the corresponding polarity in order to switch the display spheres 240, for example, from black to white or vice versa. If the display layer 24 of the e-paper film 2′ is able to display different colours, the control device 3 is able to control the display spheres 240 so that the e-paper film 2′ displays a colour desired by the user.

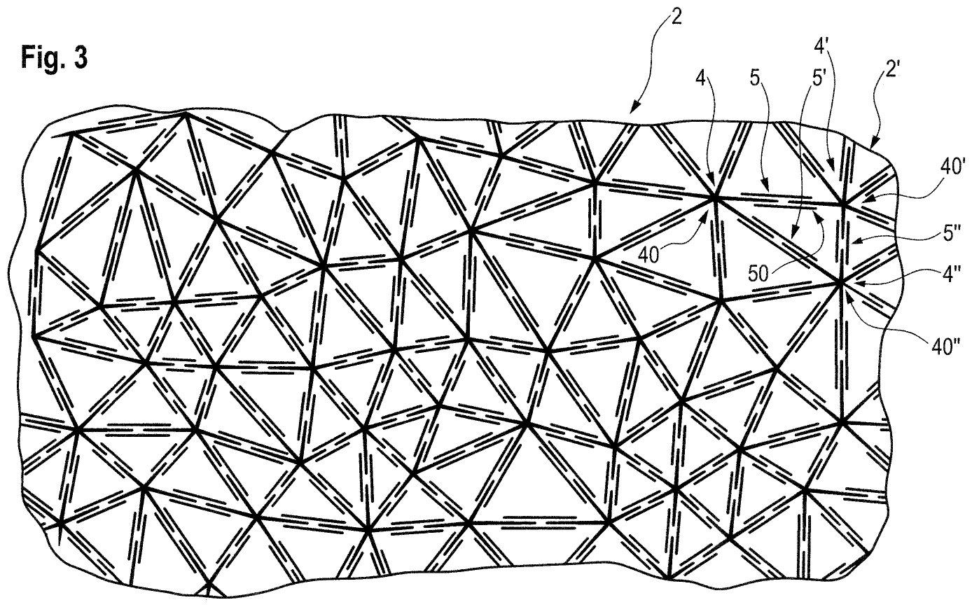

FIG. 3 shows a section of a surface of the decorative film 2 according to the invention. This decorative film 2 is provided with a plurality of compression regions 4, 4′, 4″ and expansion regions 5, 5′, 5″. Each compression region 4, 4′, 4″ has a star-shaped compression element 40, 40′, 40″, shown in detail in FIG. 4, which is formed by a plurality of compression slits 42, 43, 44, 45, 46, 47; 42′, 43′, 44′, 45′, 46′, 47′ that extend in a star shape from a common centre 41 and penetrate the decorative film 2 in the thickness direction D. When the decorative film 2 is laid flat as shown in FIG. 4, the compression slits 42, 43, 44, 45, 46, 47; 42′, 43′, 44′, 45′, 46′, 47′ each have a slit width that decreases from the centre 41 of the compression element 40 towards the respective free end of the relevant compression slit 42, 43, 44, 45, 46, 47; 42′, 43′, 44′, 45′, 46′, 47′, so that the respective compression slit 42, 43, 44, 45, 46, 47; 42′, 43′, 44′, 45′, 46′, 47′ tapers towards its free end.

Neighbouring compression elements 40, 40′ each form a pair of compression slits 42, 42′ converging towards one another. The free ends of these converging compression slits 42, 42′ do not touch each other, but are spaced apart and leave an unslit bridge region 48 between their free ends, in which the decorative film 2 is intact and thus electrically functional in the case of an e-paper film 2′. These converging compression slits 42, 42′ have a common centre axis M in their longitudinal extension.

An expansion element 50 forming the expansion region 5 is always provided between two neighbouring compression elements 40, 40′. For this purpose, as shown in FIG. 5, a first expansion slit 52 and a second expansion slit 54, which are aligned parallel to each other, extend parallel to each pair of converging compression slits 42, 42′ and laterally spaced apart therefrom on two sides of the pair of converging compression slits 42, 42′ facing away from each other. When the decorative film 2 is laid flat, the respective expansion slit 52, 54 has longitudinal edges parallel to one another, as shown in FIG. 5, and thus has a constant slit width.

The expansion slits 52, 54 also penetrate the decorative film 2 in the thickness direction D. Thus, in the case of the e-paper film 2′, both the compression slits 42, 43, 44, 45, 46, 47; 42′, 43′, 44′, 45′, 46′, 47′ and the expansion slits 52, 54 are cut locally through the cover layer 21, the first electrode layer 20, the display layer 24, the second electrode layer 22 and the supporting layer 23.

The expansion slits 52, 54, which run parallel to the common centre axis M of the compression slits 42, 42′, extend along the front third, or up to half, of the longitudinal extension of the respective associated compression slit 42, 42′ pointing towards the free end.

If a tensile force is applied to the decorative film 2 in the film surface, which acts transversely, for example at right angles, to the longitudinal extension of an expansion slit 52, 54 (as symbolically shown by the arrows E in FIG. 5), the opening width of the expansion slit 52, 54, i.e. its breadth, increases, causing the decorative film 2 in this region to stretch locally transversely to the longitudinal extension along the common centre axis M.

If a compressive force or shear force is applied to the decorative film 2 in the film surface, which acts towards the centre 41 of the compression element 40 (as symbolically shown by the arrows K in FIG. 4), the opening width of at least one compression slit 42, 42′ is reduced, so that the decorative film 2 is locally compressed in this region.

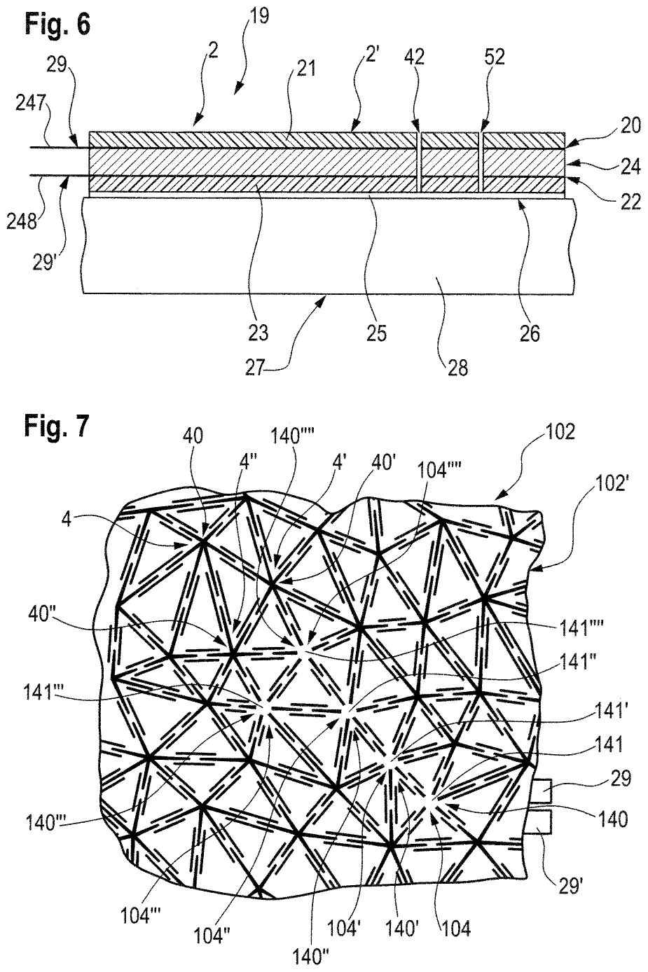

FIG. 6 shows a longitudinal section through a sandwich film 19 produced according to the method of the invention. The decorative film, which is configured as an e-paper film 2′, has the transparent upper electrode layer 20 which is electrically conductively connected to the electrical control device 3 and is provided with the transparent cover layer 21, as well as the lower electrode layer 22 which is also electrically conductively connected to the electrical control device 3 and is provided on the supporting layer 23, and the display layer 24 located therebetween.

The supporting layer 23 is provided with an adhesive layer 26 on its underside facing away from the lower electrode layer 22. The adhesive layer 26 is formed, for example, by a thin double-sided adhesive film 25; however, it can also be formed by a film of adhesive applied to the supporting layer 23 by spraying. The e-paper film 2′thus provided with the adhesive layer 26 is then laminated onto an adhesive supporting film 27 which is formed, for example, by a flexible, stretchable and compressible car wrapping film 28, as a result of which an initially not very flexible and still fairly stiff film composite is created as a sandwich film. This film composite then undergoes a laser cutting process, in which the e-paper film 2′ is cut through from its upper side, i.e. from the side with the cover layer 21, using a laser beam to form the predefined pattern of slits, the compression slit 42 and the expansion slit 52 being shown by way of example in FIG. 6. The adhesive layer 26 and the supporting film 27 remain intact, while the cuts impart flexibility, local stretchability and local compressibility to the decorative film 2 formed by the e-paper film 2′.

FIG. 7 shows a modified embodiment of a decorative film 102 designed according to the invention and formed as an e-paper film 102′, which corresponds, in principle, to the decorative film 2 of FIG. 3. As with the decorative film 2 configured as e-paper film 2′, an electrical connection tab 29, 29′ is provided on the upper electrode layer 20 and on the lower electrode layer 22, through which electrical energy is introduced into the electrode layers 20, 22 of the e-paper film 102′. In a modification to the embodiment in FIG. 3, the e-paper film 102′shown in FIG. 7 has not only compression regions 4, 4′, 4″ with star-shaped compression elements 40, 40′, 40″, the compression slits of which merge into one another in a common centre 41, but also, especially in the vicinity of the connection tabs 29, 29′, compression regions 104, 104′, 104″, 104′″, 104″″ with star-shaped compression elements 140, 140′, 140″, 140′″, 140″″, the compression slits 141, 141′, 141″, 141′″, 141″″ of which, arranged in a star shape, are not connected to one another in the centre of the respective compression element 140, 140′, 140″, 140′″, 140″″. As a result, the e-paper film 102′ is intact and whole in the respective centre 141, 141′, 141″ and electric current can flow through the respective compression element 140, 140′, 140″, 140′″, 140″″ unhindered and with low resistance in these centre regions. This improves the power supply to the compression elements 40, 40′, 40″ located further away from the connection tabs 29, 29′.

The invention is not limited to the above embodiment, which merely serves as a general explanation of the core idea of the invention. Rather, within the scope of protection, the device according to the invention can also be implemented in embodiments other than those described above. In particular, the device can have features which are a combination of the respective individual features of the claims.

Reference numbers in the claims, the description and the drawings are merely intended to facilitate understanding of the invention and are not intended to limit the scope of protection.

### LIST OF REFERENCE NUMBERS

1 Motor vehicle
2 Decorative film
2′ E-paper film
3 Control device
4 Compression region
4′ Compression region
4″ Compression region
5 Expansion region
5′ Expansion region
5″ Expansion region
10 Body skin
11 Vehicle interior
12 Vehicle body
13 Bonnet
14 Wing
15 Wing
16 Non-planar surface
17 Convex portion of 10
18 Concave portion of 10
19 Sandwich film
20 First flat (upper) transparent electrode layer
21 Cover layer
22 Second flat (lower) transparent electrode layer
23 Supporting layer
24 Decorative layer
25 Adhesive film
26 Adhesive layer
27 Supporting film
28 Car wrapping film
29 Connection tab
29′ Connection tab
30 Control lines
40 Compression element
40′ Compression element
40″ Compression element
41 Centre
42 Compression slit
42′ Compression slit
43 Compression slit
43′ Compression slit
44 Compression slit
44′ Compression slit
45 Compression slit
45′ Compression slit
46 Compression slit
46′ Compression slit
47 Compression slit
47′ Compression slit
48 Unslit bridge region
50 Expansion element
52 Expansion slit
54 Expansion slit
102 Decorative film
102′ E-paper film
104 Compression region
104′ Compression region
104″ Compression region
104′″ Compression region
104″″ Compression region
140 Compression element
140′ Compression element
140″ Compression element
140′″ Compression element
140″″ Compression element
141 Centre
141′ Centre
141″ Centre
141′″ Centre
141″″ Centre
240 Display sphere
241 Transparent housing wall
242 First pigments
243 Transparent fluid
244 Second pigments
246 Interior space
247 First electrically conductive connection
248 Second electrically conductive connection
D Thickness direction
E Arrow (stretching)
K Arrow (compressing)
M Centre line
Q Electrical power source

1. A method for applying an inherently stiff decorative film with a decorative layer onto a non-planar surface of an outer body skin of a motor vehicle, the method comprising:
a) providing the decorative film;
b) applying an adhesive layer onto the decorative film;
c) applying the decorative film provided with the adhesive layer onto an adhesive supporting film in order to form a sandwich film;
d) cutting a predefined pattern of compression slits which extend away from one another in a star shape or are designed in a diamond shape and linear expansion slits into the decorative film in such a way that the compression slits and the expansion slits penetrate the decorative film in the thickness direction;
e) applying the sandwich film onto the non-planar surface, the sandwich film being adapted to convex regions of the non-planar surface by stretching the adhesive supporting film and the decorative film, and the sandwich film being adapted to concave regions of the non-planar surface by compressing the adhesive supporting film and the decorative film.

2. A method for applying an inherently stiff decorative film with a decorative layer onto a non-planar surface of an outer body skin of a motor vehicle, the method comprising:
a) providing the decorative film;
b) applying an adhesive layer onto the decorative film;
c′) cutting a predefined pattern of compression slits which extend away from one another in a star shape or are designed in a diamond shape and linear expansion slits into the e-paper film in such a way that the compression slits and the expansion slits penetrate the decorative film in the thickness direction;
d′) applying the decorative film provided with the adhesive layer onto an adhesive supporting film in order to form a sandwich film;
e) applying the sandwich film onto the non-planar surface, the sandwich film being adapted to convex regions of the non-planar surface by stretching the adhesive supporting film and the decorative film, and the sandwich film being adapted to concave regions of the non-planar surface by compressing the adhesive supporting film and the decorative film.

3. The method according to claim 1, wherein the predefined pattern of compression slits and expansion slits is cut into the decorative film by means of a laser beam.

4. The method according to claim 1, wherein after the sandwich film has been applied to the non-planar surface in a further step e) a protective layer consisting of a transparent protective film or a clear lacquer layer is applied to the sandwich film.

5. The method according to claim 1, wherein in order to determine the predefined pattern, convex regions and concave regions of the non-planar surface are first identified by means of a CAD program and marked with a convex marking and a concave marking, respectively,
the non-planar surface marked in this way is unwrapped into a plane,
the coordinates of the convex markings and the concave markings are transferred to the planar decorative layer, and
the convex markings determine expansion regions into which the expansion slits are cut, and
the concave markings determine compression regions into which the compression slits, which extend away from one another in a star shape or are designed in a diamond shape, are cut.

6. The method according to claim 1, wherein first compression regions are provided, in which the compression slits, which extend away from one another in a star shape, have a common centre that penetrates the decorative film in the thickness direction.

7. The method according to claim 1, wherein second compression regions are provided, in which the inner ends of the compression slits, which extend away from one another in a star shape, are spaced apart from one another in the centre of the compression element, so that an intact region of the decorative film is formed in the centre, in which the decorative film is not cut through in the thickness direction.

8. The method according to claim 1, preceding wherein the decorative film provided in step a) is trimmed to a predefined outer contour during or before step a), and
the sandwich film formed in step c) or d′) is then trimmed to the same outer contour, the thereby made cutting line that cuts through the supporting film being spaced apart from the outer contour line of the decorative film.

9. The method according to claim 1, wherein the decorative film has a first electrode layer, a second electrode layer and a decorative layer arranged between the two electrode layers, the light reflection properties or light transmission properties of which can be changed by applying an electrical voltage, and
the first electrode layer and the second electrode layer of the decorative film provided in step a) are provided, during or before step a), with electrically conductive contact tabs, each of which is pivotable about an axis lying in the plane of the respective electrode layer.

10. A sandwich film with a decorative film which is bonded to a supporting film by means of an adhesive layer, produced by a method according to claim 1.

11. A motor vehicle, having at least one surface which has non-planar surface regions and which has been provided, at least in certain regions, by means of a method according to claim 1, with a sandwich film having a decorative film.

12. The method according to claim 2, wherein the predefined pattern of compression slits and expansion slits is cut into the decorative film by means of a laser beam.

13. The method according to claim 2, wherein after the sandwich film has been applied to the non-planar surface in a further step e) a protective layer consisting of a transparent protective film or a clear lacquer layer is applied to the sandwich film.

14. The method according to claim 2, wherein in order to determine the predefined pattern, convex regions and concave regions of the non-planar surface are first identified by means of a CAD program and marked with a convex marking and a concave marking, respectively,
the non-planar surface marked in this way is unwrapped into a plane,
the coordinates of the convex markings and the concave markings are transferred to the planar decorative layer, and
the convex markings determine expansion regions into which the expansion slits are cut, and
the concave markings determine compression regions into which the compression slits, which extend away from one another in a star shape or are designed in a diamond shape, are cut.

15. The method according to claim 2, wherein first compression regions are provided, in which the compression slits, which extend away from one another in a star shape, have a common centre that penetrates the decorative film in the thickness direction.

16. The method according to claim 2, wherein second compression regions are provided, in which the inner ends of the compression slits, which extend away from one another in a star shape, are spaced apart from one another in the centre of the compression element, so that an intact region of the decorative film is formed in the centre, in which the decorative film is not cut through in the thickness direction.

17. The method according to claim 2, wherein the decorative film provided in step a) is trimmed to a predefined outer contour during or before step a), and
the sandwich film formed in step c) or d′) is then trimmed to the same outer contour, the thereby made cutting line that cuts through the supporting film being spaced apart from the outer contour line of the decorative film.

18. The method according to claim 2, wherein the decorative film has a first electrode layer, a second electrode layer and a decorative layer arranged between the two electrode layers, the light reflection properties or light transmission properties of which can be changed by applying an electrical voltage, and
the first electrode layer and the second electrode layer of the decorative film provided in step a) are provided, during or before step a), with electrically conductive contact tabs, each of which is pivotable about an axis lying in the plane of the respective electrode layer.

19. A sandwich film with a decorative film which is bonded to a supporting film by means of an adhesive layer, produced by a method according to claim 2.

20. A motor vehicle, having at least one surface which has non-planar surface regions and which has been provided, at least in certain regions, by means of a method according to claim 2, with a sandwich film having a decorative film.
